(19) United States
(12) Patent Application Publication
(10) Pub. No.: US 2006/0090803 A1
(43) Pub. Date: May 4, 2006

(54) Device for the continuous change of the flow rate of a medium

(76) Inventors: Ing. Zdravko Paluncic, Ludwigshafen (DE); Andreas Schonfeld, St. Leon-Rot (DE); Jurgen Hack, Sandhausen (DE)

Correspondence Address: WENDEROTH, LIND & PONACK, L.L.P., 2033 K STREET N. W., SUITE 800, WASHINGTON, DC, 20006-1021, US

(21) Appl. No.: 11/260,140

(22) Filed: Oct. 28, 2005

(30) Foreign Application Priority Data
Oct. 30, 2004 (DE) 20 2004 016 833.2
Aug. 19, 2005 (EP) 05 018 005.8

(51) Int. Cl. G05D 7/01

(52) U.S. Cl. 138/43; 138/46

(57) ABSTRACT

A device for the continuous change of the flow rate of a viscous medium e.g. hydraulic oils or lubricating greases with e.g. a conical throttle insert (1) with a smooth surface and axially movable in a conical bore (3) of a housing (4) in such a manner that different gap widths and/or lengths between throttle insert (1) and housing (4) connect a housing inlet (5) with a housing outlet (6) for the medium. Alternatively, the device may include circular cylindrical throttle insert (1) having a circumferential spiral groove (2) and being axially movable in a circular cylindrical bore (3) of a housing (4) in such a manner that different lengths of the circumferential groove (2) connect a housing inlet (5) with a housing outlet (6) for the medium being metered.

### BACKGROUND OF THE INVENTION

1. Field of the Invention

The invention concerns a device for the continuous change of the flow rate of a viscous medium e.g. hydraulic oils or lubricating greases.

2. Description of the Related Art

DD 269 418 Al discloses a device for the metering of small quantities of oil by means of a screw pump, whereby in an oil-filled housing the oil is supplied to a lubricating point through a spiral oil groove via a gap. Hereby at least two spiral oil grooves are arranged at a certain interval on a shaft. The device also includes a sliding sleeve with a ring groove. The sliding sleeve is operated by a translation screw and the ring groove features connections for movable conduits. The translation screw moves the oil through the bearing gap between the shaft and the sliding sleeve. The change in distance between the outlet of the oil groove and the ring groove results in a change of the throttle distance. The longer the throttle distance, the greater the counter pressure and the smaller the quantity displaced. The oil that cannot be delivered does not pass through the gap and remains in the housing. Such a device is of relatively complicated construction which works out unfavorably with regard to the cost of manufacture, operation and maintenance.

### SUMMARY OF THE INVENTION

The purpose of the present invention is to propose a device for the continuous change of the flow rate of a viscous medium e.g. hydraulic oils or lubricating greases that is of simpler construction and offers reliable operation.

In a device for the continuous change of the flow rate of a viscous medium e.g. hydraulic oils or lubricating greases this purpose is achieved by the use of a conical throttle insert that has a smooth surface and is axially movable in, e.g., a conical bore in such a manner that different gap widths and/or lengths between throttle insert and housing connect a housing inlet with a housing outlet for the medium, or by the use of a circular cylindrical throttle insert with a circumferential spiral groove. The insert is axially movable in a circular cylindrical bore of a housing in such a manner that different lengths of the circumferential groove connect a housing inlet with a housing outlet for the medium being metered.

Such a metering device is of simple construction and functions reliably.

In a further development of the inventive idea, the cross-section of the circumferential groove changes along its length, preferably changes in depth along its length so that only a slight axial displacement of the metering insert is required for the desired change of the flow rate.

In this case the cross-section of the circumferential groove preferably decreases continuously from the inlet side to the outlet side.

A further inventive idea proposes that the inlet leads into a chamber of the housing at the front of the throttle insert. This means that the pressure of the viscous medium on the inlet side moves the throttle insert after release into its new operating position with a new flow resistance. However, an additional spring element can be useful here.

The housing outlet preferably branches off from the circular cylindrical circumference of the bore.

For simplicity of operation it is advantageous if the throttle insert is continuously axially movable with the aid of a throttle screw.

Metering accuracy is further enhanced if, in accordance with another feature of the invention, the end of the throttle insert opposite the housing inlet is sealed against the circular cylindrical wall by means of an O-ring that is preferably mounted on the throttle insert.

To ensure a preselected rate of flow it may be possible to lock the throttle screw in its operating position.

While the pitch of the spiral groove and the cross-section of the circumferential groove determine the characteristic of the throttle device, it is particularly advantageous if the throttle insert, which is accommodated in the housing is exchangeable with another throttle insert having a different throttle characteristic.

Further aims, features, advantages and application possibilities of the invention are evident from the following description of embodiments with reference to the drawing. All features described and/or illustrated, alone or in any combination, represent the subject of this invention, also independent of their summary in individual claims or their cross-reference.

### BRIEF DESCRIPTION OF THE DRAWINGS

FIG. 1 is a cross-sectional view of a throttle device constructed in accordance with an embodiment of the present invention.

FIG. 2A is a side view of a throttle insert employed in the throttle device of FIG. 1.

FIG. 2B is a cross sectional view taken along line A-A of FIG. 1.

FIG. 3 is a cross sectional view of a cylindrical throttle insert constructed in accordance with a further embodiment of the present invention.

FIG. 4 is a cross sectional view of another throttle insert having a conical portion.

### DETAILED DESCRIPTION OF THE INVENTION

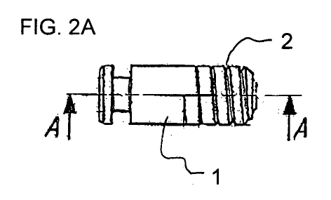

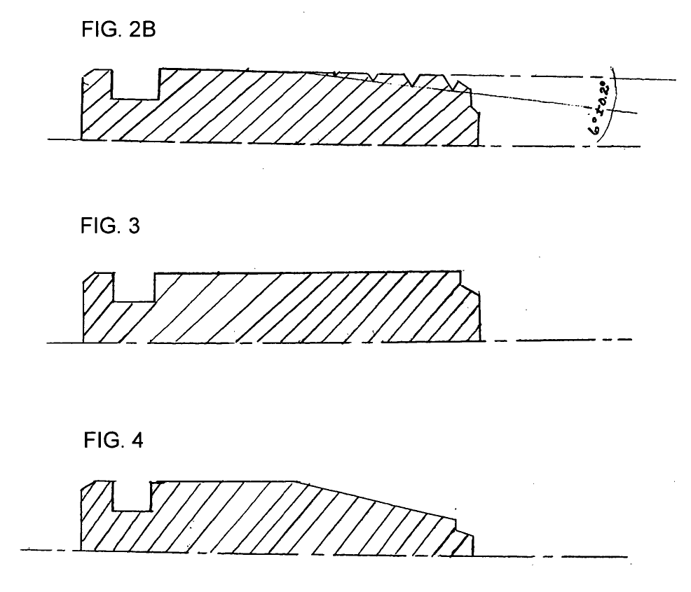

The only drawing shows a throttle device demonstrating the invention according to an embodiment with a circumferential spiral groove on the throttle insert (see FIG. 2A). The throttle device illustrated has a housing 4 with a blind circular cylindrical bore 3. The lower part (in the drawing) of the bore 3 accommodates a circular cylindrical throttle insert 1 that is axially displaceable with minimum clearance. The throttle insert 1 has a circumferential spiral groove 2.

At the front below the throttle insert 2 there is a chamber 7 in the housing 4 into which a housing inlet 5 for the medium comes out. A housing outlet 6 for the medium branches off from the area near the bore 3 in which the throttle insert 1 can axially move to and fro.

Because of the axial displacement of the throttle insert in the bore 3, the housing inlet 5 and housing outlet 6 are interconnected over a greater or lesser section of the circumferential spiral groove 2. The flow resistance is correspondingly greater or lesser. As shown in FIG. 2B, the spiral groove 2 may, e.g., have a continuously increasing cross-section, in particular a continuously increasing depth from the inlet end to the outlet end. As shown in FIG. 2B, the circumferential surface of the throttle insert is cylindrical, but the depth of the groove 2 increases in a direction toward the front of the insert. The pitch of the spiral groove and its cross-section determine the throttle characteristic of the device.

The axial displacement of the throttle insert 1 in the bore 3 can be effected by means of a metering screw 8 accommodated in a widened threaded section of the bore 3. The position of the throttle screw 3 can be fixed by means of a retaining ring 10 and/or a pressure plate 11.

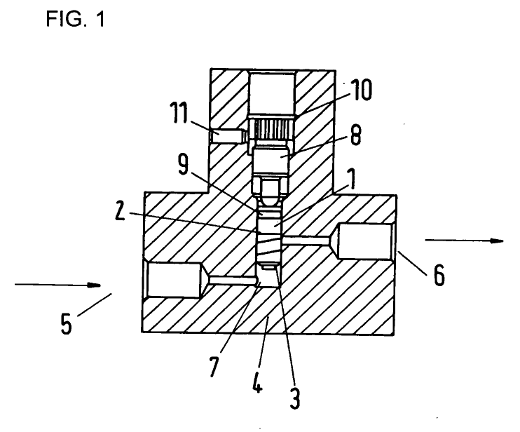

If the throttle screw 8 is adjusted upward (in FIG. 1) in such a manner that the throttle insert 1 can move axially (in FIG. 1) upward, this displacement is effected by the medium itself during the next application of pressure to the housing inlet 5 until the throttle insert 1 comes to a stop again at the metering screw 8.

The throttle insert 1 is sealed against the inner wall of the bore 3 by an O-ring in its upper end so that the medium cannot escape upwards (in FIG. 1).

Similarly functional is a device in which the throttle insert 1 does not have a circumferential groove (see FIG. 3), but a smooth outer surface (i.e. without a spiral groove) and in particular, a conical surface (see FIG. 4), whereby the conical portion tapers slightly from top to bottom (in FIG. 1) and is axially movable in a likewise conical bore of the housing 4. With an axial adjustment like this there are no effective groove sections of different lengths, but for metering purposes there are gaps of different width and/or length between throttle insert 1 and housing 4. Note that the cylindrical surface of the throttle insert (FIG. 3) may employed in a conical chamber. Also, as shown in FIG. 4, the outer circumferential surface of the throttle insert may include a cylindrical portion and a conical portion. Other combinations of surfaces of the chamber and the throttle insert are possible.

### REFERENCE LIST

1 Throttle insert
2 Groove
3 Bore
4 Housing
5 Housing inlet
6 Housing outlet
7 Chamber
8 Throttle screw
9 O-ring
10 Retaining ring
11 Pressure plate

1. A device for the continuous change of the flow rate of a viscous medium, said device comprising a circular cylindrical throttle insert (1) with a circumferential spiral groove (2) and axially movable in a circular cylindrical bore (3) of a housing (4) in such a manner that different lengths of the circumferential groove (2) connect a housing inlet (5) with a housing outlet (6) for the medium being metered.

2. A device as claimed in claim 1, wherein the circumferential spiral groove (2) has a cross-section that changes along its length.

3. A device as claimed in claim 2, wherein the cross-section of the circumferential groove (2) decreases continuously from the inlet side to the outlet side.

4. A device as claimed in claim 1, wherein the housing inlet (5) leads into a chamber (7) of the housing (4) at the front of the throttle insert (1).

5. A device as claimed in claim 1, wherein the housing outlet (6) branches off from the circular cylindrical circumference of the bore (3).

6. A device as claimed in claim 1, wherein the throttle insert (1) is continuously axially movable by means of a throttle screw (8).

7. A device as claimed in claim 1, wherein the end of the throttle insert (1) opposite the housing inlet (5) is sealed against the circular cylindrical wall of the bore (3) by means of an O-ring (9).

8. A device as claimed in claim 6, wherein the throttle screw (8) can be locked in its operating position.

9. A device as claimed in claim 1, wherein the throttle insert (1) is mounted exchangeable in the housing (4).

10. A device as claimed in claim 1, wherein the viscous fluid is hydraulic oil or lubricating grease.

11. A device as claimed in claim 1, wherein the circumferential spiral groove has a depth that changes along its length.

12. A device for changing the flow rate of a viscous medium, said device comprising a conical throttle insert having a smooth surface and being axially movable in a conical bore of a housing in such a manner that different gap widths and/or lengths between the throttle insert and the housing connect a housing inlet with a housing outlet for the medium.

13. A device as claimed in claim 12, wherein the housing inlet (5) leads into a chamber (7) of the housing (4) at the front of the throttle insert (1).

14. A device as claimed in claim 12, wherein the housing outlet (6) branches off from the circular cylindrical circumference of the bore (3).

15. A device as claimed in claim 12, wherein the throttle insert (1) is continuously axially movable by means of a throttle screw (8).

16. A device as claimed in claim 12, wherein the end of the throttle insert (1) opposite the housing inlet (5) is sealed against the circular cylindrical wall of the bore (3) by means of an O-ring (9).

17. A device as claimed in claim 15, wherein the throttle screw (8) can be locked in its operating position.

18. A device as claimed in claim 12, wherein the throttle insert (1) is mounted so as to be exchangeable in the housing (4).
